(19) United States
(12) Patent Application Publication
(10) Pub. No.: US 2015/0164268 A1
(43) Pub. Date: Jun. 18, 2015

(54) Combination Lid and Utensil Holder

(71) Applicants: David Hurley, Mount Dora, FL (US); David G. Mayer, West Bend, WI (US)

(72) Inventors: David Hurley, Mount Dora, FL (US); David G. Mayer, West Bend, WI (US)

(21) Appl. No.: 14/108,768

(22) Filed: Dec. 17, 2013

(51) Int. Cl. A47J 36/12; A47J 27/00

(52) U.S. Cl. CPC A47J 36/12; A47J 27/00

(57) ABSTRACT

A vessel-attachable suspension device for temporary suspension of one or more things above the open top of a pot or pan is provided and includes an elongate member having top and bottom portions and a middle portion therebetween, the top portion having a lid-engaging cradle, the bottom portion having a handle-receiving hook, and the middle portion having at least one utensil-receiving opening. The handle-receiving hook is engageable with a handle of the pot or pan to hold the suspension device upright with the lid-engaging cradle and utensil-receiving opening(s) above the pot or pan.

### FIELD

The present invention relates to lid holders for cooking vessels and more particularly to a combination lid and utensil holder.

### BACKGROUND

Traditionally a lid is involved when cooking with a vessel such as a pot or pan. Very often it is desirable that the lid be lifted so that the user can access the contents of the vessel either for stirring, adding ingredients or a host of other reasons. Such a need may occur many times over the course of cooking a particular dish. When the lid is removed water that has condensed on the underside of the lid or other matter from the cooking food often collects and drips off the lid onto the counter or floor or whatever else is located below the lid. This causes a mess and can also result in the user being burned by a hot lid. Additionally, the user typically has one hand occupied with holding the lid while simultaneously stirring the vessel contents, adding ingredients, etc. Sometimes a user may set the hot lid on a counter top or other surface so that they have both hands available for cooking but doing so leaves a mess on the surface on which the lid was set and also does not protect the user or counter top from being burned by the hot lid.

Another problem arises when the user stirs the contents of the vessel and then rests the stirring utensil on the side of the vessel. Oftentimes the utensil will slide down the side of the vessel and into the food being prepared causing the user to have to reach into the food to retrieve the utensil. All of this can make cooking messy and unnecessarily complicated.

It would be desirable to have a combination lid and utensil holder that suspends the lid of a vessel in a position so that condensed water or any other matter that has collected on the underside of the lid can drip back into the vessel. It would also be desirable to have a combination lid and utensil holder that can hold a utensil being used in the food preparation in a manner so that it is both easily accessible and unable to slide into the contents of the vessel. Furthermore, it would be desirable to have a combination lid and utensil holder that suspends a hot lid over a vessel so that the user does not have to hold onto the lid, thereby reducing the risk of the user being burned.

This device overcomes certain problems and shortcomings in the prior art, including those mentioned above and others, and provides advantages for a combination lid and utensil holder not previously provided.

### SUMMARY

In accordance with the present device, a vessel-attachable suspension device for temporary suspension of one or more things above the open top of a pot or pan, also referred to herein as a “cookvessel.” The suspension device of this invention overcomes certain problems and shortcomings of the prior art and provides a unique structure satisfying needs in the cooking industry.

The suspension device of this invention includes an elongate member having top and bottom portions and a middle portion therebetween, the top portion having a lid-engaging cradle, the bottom portion having a handle-receiving hook, and the middle portion having at least one utensil-receiving opening. The handle-receiving hook is engageable with a handle of the cookvessel to hold the suspension device upright with the lid-engaging cradle and utensil-receiving opening(s) above the cookvessel.

In highly preferred embodiments, the cradle is configured to suspend the lid in an orientation such that the annular cookvessel-engaging edge of the lid is in a near vertical orientation with a lower portion of such annular edge being over the open top of the cookvessel. It is also highly preferred the lid-engaging cradle is offset from a position over the open top of the cookvessel. Preferably, the lid-engaging cradle includes two elongated prongs spaced apart from each other, the prongs frictionally engaging a central knob on the lid.

It is highly preferred that the elongate member have an elongate center region and the utensil-receiving openings are slots angled toward the center region. In some preferred embodiments, the utensil-receiving openings are different sizes and shapes from each other.

Preferably, the elongate member is formed of a heat-resistant plastic. In other preferred embodiments, the elongate member is metal.

The term “cookvessel” as used herein means a pot or pan.

The term “utensil” as used herein means anything which is used to contact and manipulate food in the cookvessel, including but not limited to spoons, forks and spatulas.

As used herein, the term “above” as applied to the suspension of things related to the open top of a cookvessel means at a level higher than the top of the cookvessel.

As used herein, the term “over” as applied to the lower portion of the annular cookvessel-engaging edge of the lid means immediately above but also including the space defined by the uppermost portion of the cookvessel.

### BRIEF DESCRIPTION OF THE DRAWINGS

The drawings illustrate a preferred embodiment including the above-noted characteristics and features of the device. The device will be readily understood from the descriptions and drawings. In the drawings:

FIG. 1 is a perspective view of the vessel-attachable suspension device attached to a vessel and suspending a lid.

FIG. 2 is a side view of the vessel-attachable suspension device of FIG. 1.

FIG. 3 is a front view of the vessel-attachable suspension device of FIG. 1.

FIG. 4 is an exploded view of the vessel-attachable suspension device of FIG. 1.

FIG. 5 is a perspective view of the vessel-attachable suspension device of FIG. 1 with a utensil in the utensil-receiving opening.

FIG. 6 is a side view of the vessel-attachable suspension device of FIG. 5 with utensil.

FIG. 7 is a front perspective view of the vessel-attachable suspension device of FIG. 1 without a vessel or lid.

FIG. 8 is a back perspective view of the vessel-attachable suspension device of FIG. 7.

FIG. 9 is a side view of the vessel-attachable suspension device of FIG. 7.

FIG. 10 is a front view of the vessel-attachable suspension device of FIG. 7.

FIG. 11 is a further view of the vessel-attachable suspension device of FIG. 10 taken in the direction of line 11-11 and showing an angled utensil-receiving opening.

FIG. 12 is a further view of the vessel-attachable suspension device of FIG. 10 taken in the direction of line 12-12 and showing another angled utensil-receiving opening.

### DETAILED DESCRIPTION

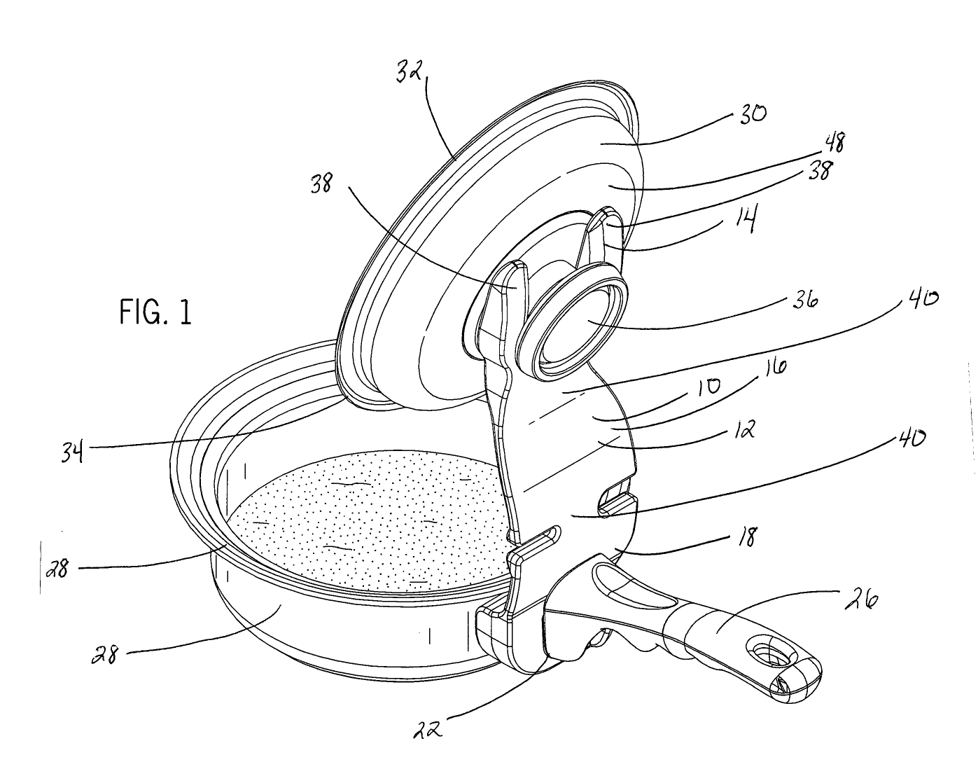

Referring to FIGS. 1-12, a vessel-attachable suspension device 10 in accordance with the present invention is generally designated by the reference numeral 10. Vessel-attachable suspension device 10 allows for temporary suspension of one or more things, such as a lid 30 or other vessel cover, above the open top of a cookvessel 28 (this term refers to a pot or pan as defined above). Suspension device 10 includes an elongate member 12 having top 14 and bottom 18 portions and a middle portion 16 therebetween, the top portion 14 having a lid-engaging cradle 20, the bottom portion 18 having a handle-receiving hook 22, and the middle portion 16 having at least one utensil-receiving opening 24. Handle-receiving hook 22 is engageable with a handle 26 of the cookvessel 28 to hold suspension device 10 upright with lid-engaging cradle 20 and utensil-receiving openings 24 above cookvessel 28.

As seen in FIGS. 1-6, cradle 20 is configured to suspend lid 30 in an orientation such that the annular cookvessel-engaging edge 32 of lid 30 is in a near vertical orientation with a lower portion 34 of such annular edge 32 being over the open top 44 of the cookvessel 28.

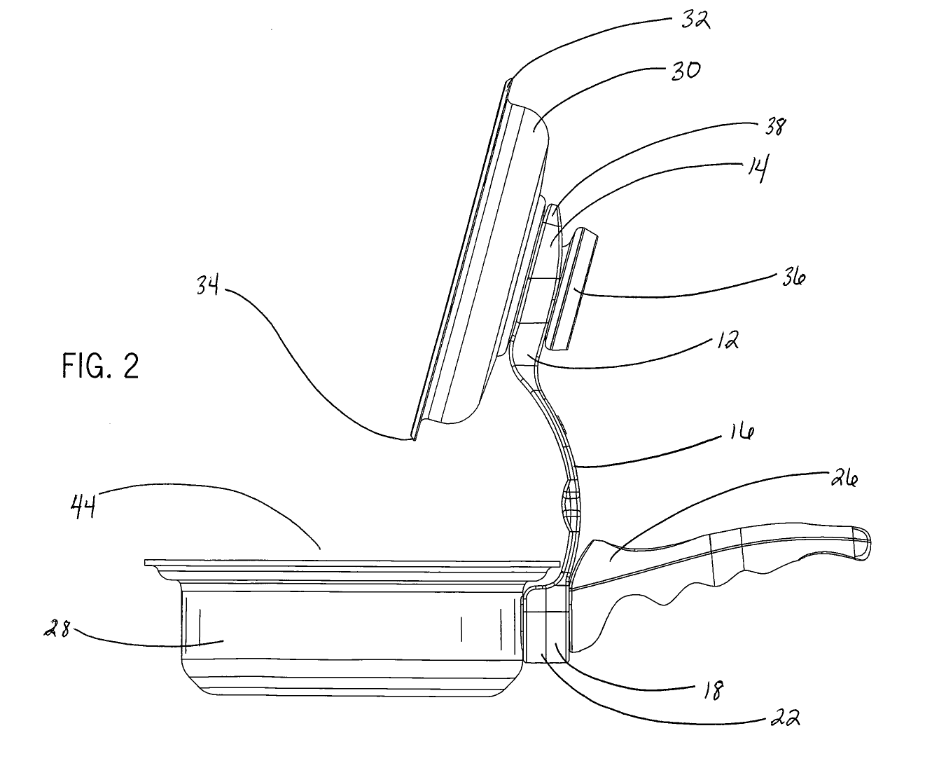

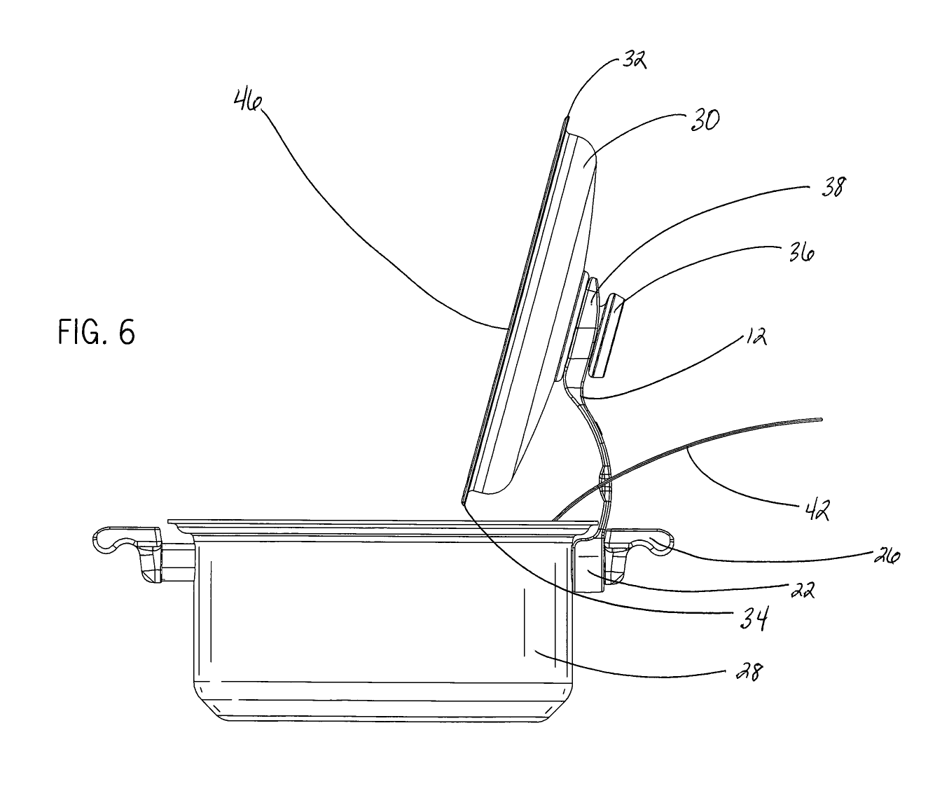

FIGS. 2 and 6 illustrate best that the lower portion 34 of the annular edge 32 is over the open cookvessel 28. Oftentimes during the cooking process condensation or food accumulates on the underside 46 of lid 30. The near vertical orientation allows the condensation or other matter that has collected to drip back into cookvessel 28 when lid 30 is suspended by suspension device 10 above cookvessel 28. This is also aided by lid-engaging cradle 20 being offset from a position over the open top 44 of cookvessel 28 as seen in FIG. 2.

Additionally, this orientation eliminates the mess that is caused when lid 30 would otherwise be placed on a counter top or other surface and it also provides a safe place for the user to put a hot lid 30 while cooking. This allows the user to have both hands available for cooking.

FIG. 3 illustrates that suspension device 10 works well with a lid 30 that has a central knob 36 or other handle which is centrally placed on top side 48 of lid 30. In these orientations, lid-engaging cradle 20 engages central knob 36. Alternatively, suspension device 10 can also be used with lids 30 that have knobs or handles which are offset from a center portion of the top side 48 of a lid 30 (not shown).

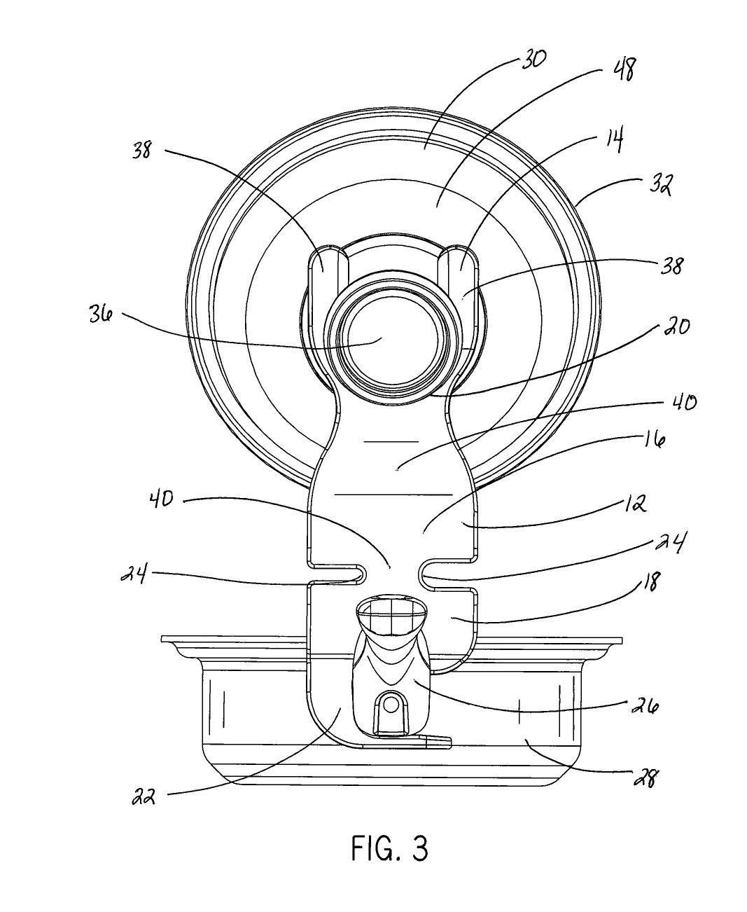

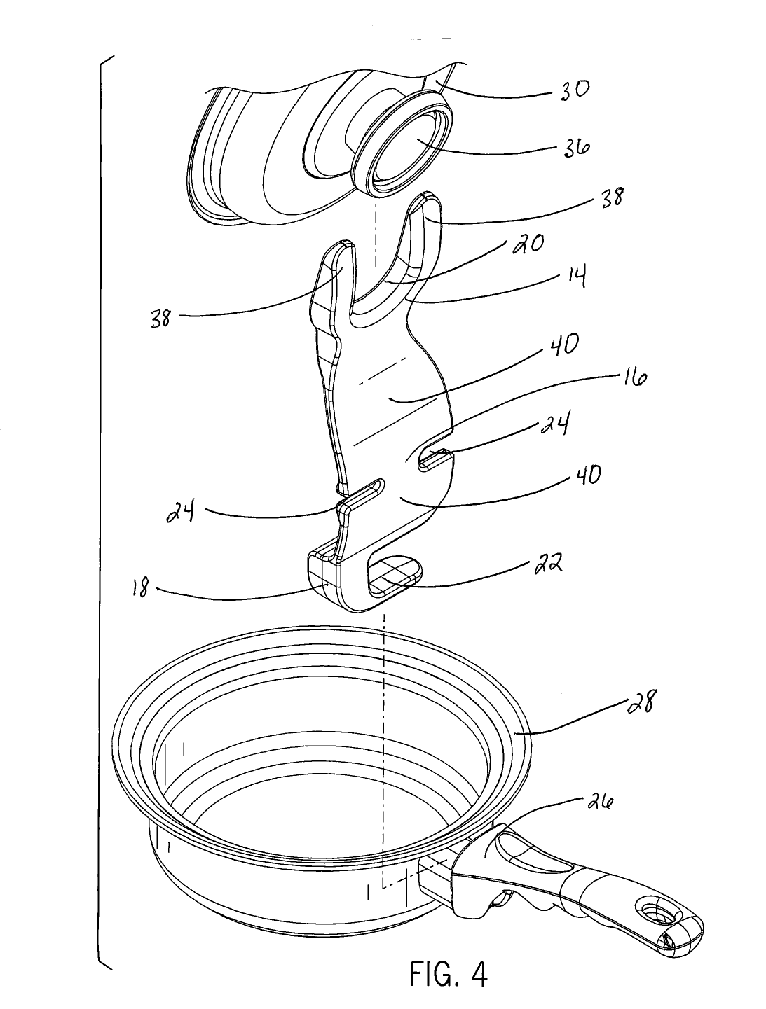

FIG. 4 is an exploded view which illustrates that lid-engaging cradle 20 includes two elongated prongs 38 spaced apart from each other. When central knob 36 or handle on lid 30 is placed into prongs 38, prongs 38 frictionally engage knob 36 and hold it in place until the user places lid 30 back on cookvessel 28.

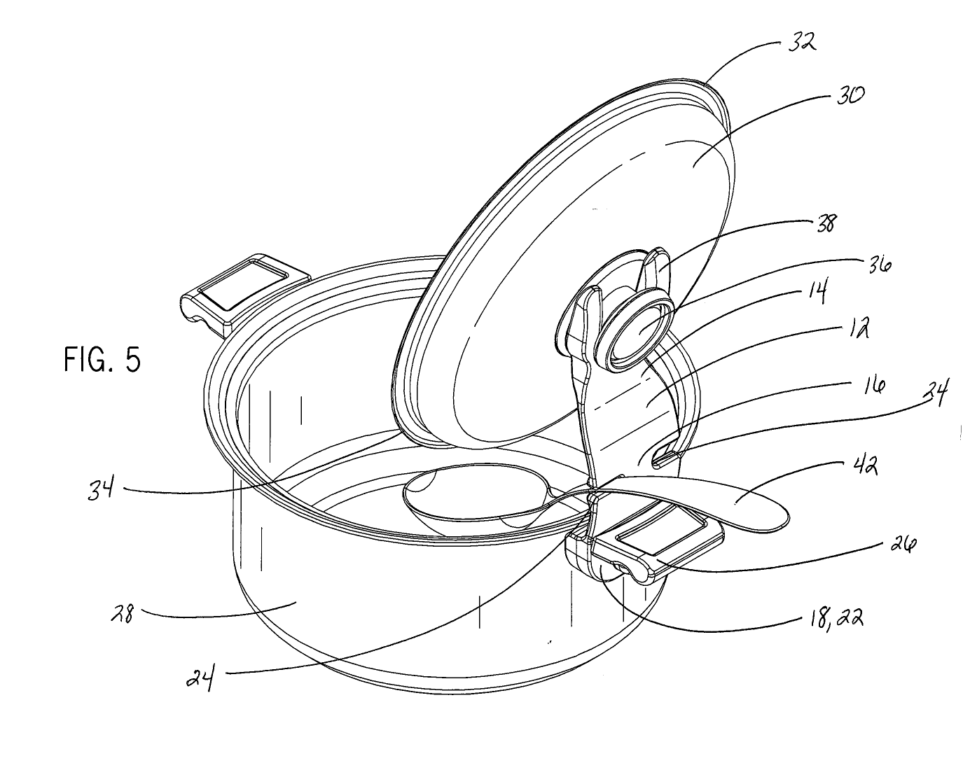

FIGS. 5-6 illustrate that elongate member 10 includes an elongate center region 40 which extends the length of elongate member 10. Center region 40 includes at least one (and sometimes many) utensil-receiving openings 24 which are slots that are angled toward center region 40 in some embodiments.

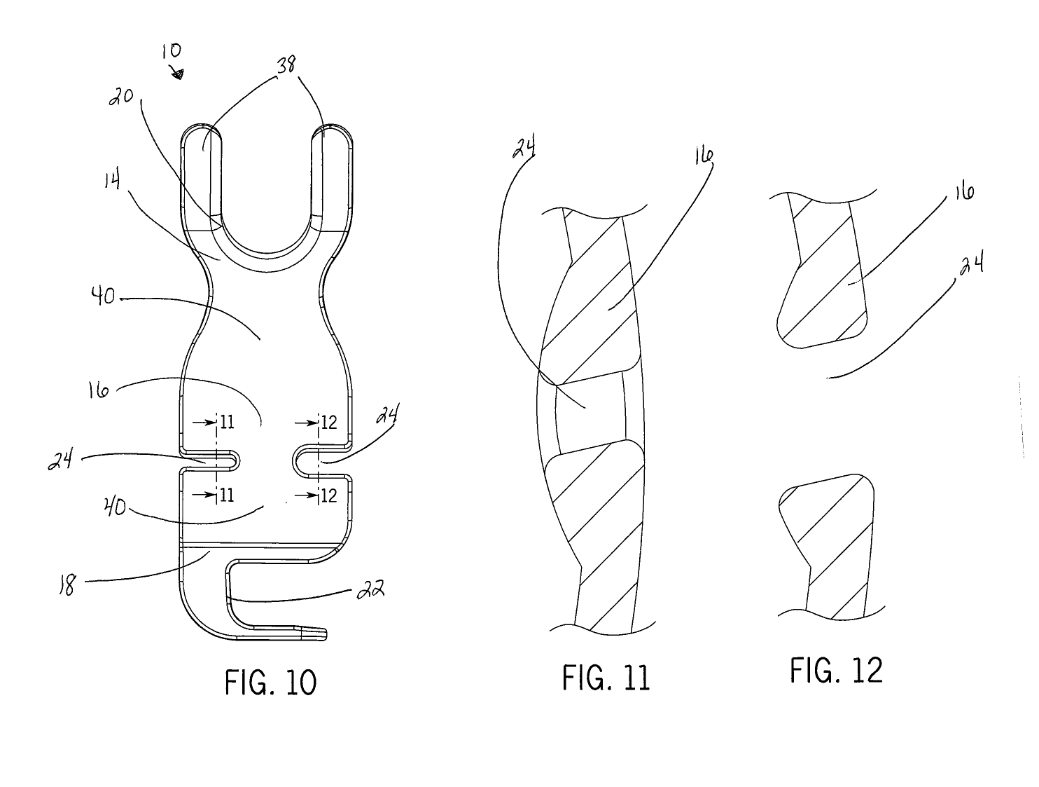

Openings 24 are angled to assist in holding a utensil 42 in utensil-receiving opening 24, however, openings 24 can also be parallel with the cookvessel 28 (not angled toward the center region). FIGS. 11-12 illustrate openings 24 which are angled inwardly toward center region 40. Angled openings 24 assist with holding utensil 42 in openings 24. FIG. 10 illustrates openings 24 which are not angled inwardly. Utensil 42 is also held in opening 24 through frictional engagement between utensil 42 and opening 24. Both FIGS. 5 and 6 show utensil 42 in utensil-receiving opening 24.

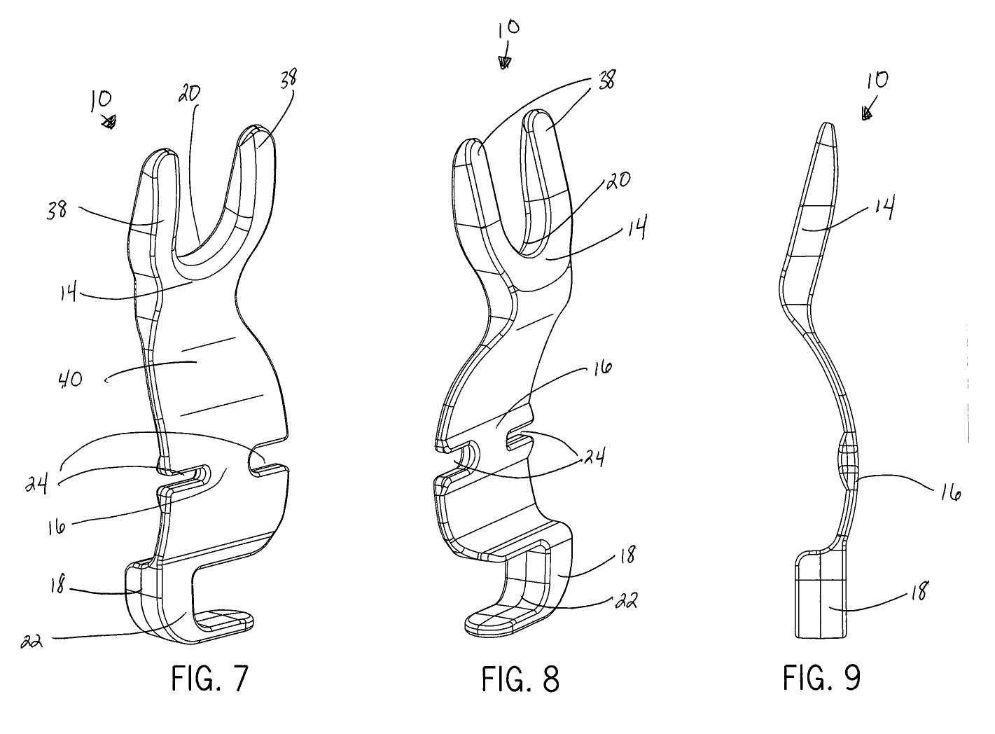

FIGS. 7-10 illustrate elongate member 10 in detail. As seen in FIGS. 7 and 10, in some embodiments, utensil-receiving openings 24 can be different sizes and shapes from each other. In other embodiments, openings 24 are the same shape and/or size (not shown). Larger and wider openings 24 are sometimes preferable to accommodate utensils 42 with larger handles such as wooden spoons or whisks. In contrast, sometimes smaller and narrower openings 24 are preferable to accommodate and hold narrow utensils 42 such as plastic or metal spoons and spatulas.

Elongate member 10 can be made of a cast or injection-molded, heat-resistant plastic or even various types of metal for added durability. Suspension device 10 can be used with any pot or pan that has a handle 26 for handle-receiving hook 22 to engage. Therefore, it can be used with a variety of pots and pans of many different shapes and sizes. For example, FIGS. 1-4 illustrate suspension device 10 engaged with a pan handle 26 while FIGS. 5-6 illustrate suspension device 10 engaged with a pot handle 26.

A wide variety of materials are available for the various parts discussed and illustrated herein. While the principles of this device have been described in connection with specific embodiments, it should be understood clearly that these descriptions are made only by way of example and are not intended to limit the scope of the device.

1. A vessel-attachable suspension device for temporary suspension of one or more things above the open top of a cookvessel comprising an elongate member having top and bottom portions and a middle portion therebetween, the top portion having a lid-engaging cradle, the bottom portion having a handle-receiving hook, and the middle portion having at least one utensil-receiving opening, whereby the handle-receiving hook is engageable with a handle of the cookvessel to hold the suspension device upright with the lid-engaging cradle and utensil-receiving opening(s) above the cookvessel.

2. The suspension device of claim 1 wherein the cradle is configured to suspend a lid in an orientation such that the annular cookvessel-engaging edge of the lid is in a near vertical orientation with a lower portion of such annular edge being over the open top of the cookvessel.

3. The suspension device of claim 2 wherein the lid-engaging cradle is offset from a position over the open top of the cookvessel.

4. The suspension device of claim 1 wherein the lid is of the type having a central knob and the lid-engaging cradle engages the central knob.

5. The suspension device of claim 4 wherein the lid-engaging cradle includes two elongated prongs spaced apart from each other, the prongs frictionally engaging the knob.

6. The suspension device of claim 1 wherein the elongate member has an elongate center region and the utensil-receiving openings are slots angled toward the center region.

7. The suspension device of claim 1 wherein the utensil-receiving openings are different sizes and shapes from each other.

8. The suspension device of claim 1 wherein the elongate member is a heat-resistant plastic.

9. The suspension device of claim 1 wherein the elongate member is metal.

10. In combination, (a) vessel-attachable suspension device for temporary suspension of one or more things above the open top of a cookvessel; and (b) a cookvessel, the improvement comprising an elongate member having top and bottom portions and a middle portion therebetween, the top portion having a lid-engaging cradle, the bottom portion having a handle-receiving hook, and the middle portion having at least one utensil-receiving opening whereby the handle-receiving hook is engageable with a handle of the cookvessel to hold the vessel-attachable suspension device upright with the lid-engaging cradle and utensil-receiving opening(s) above the cookvessel.

11. The suspension device of claim 10 wherein the cradle is configured to suspend a lid in an orientation such that the annular cookvessel-engaging edge of the lid is in a near vertical orientation with a lower portion of such annular edge being over the open top of the cookvessel.

12. The suspension device of claim 11 wherein the lid-engaging cradle is offset from a position over the open top of the cookvessel.

13. The suspension device of claim 10 wherein the lid is of the type having a central knob and the lid-engaging cradle engages the central knob.

14. The suspension device of claim 13 wherein the lid-engaging cradle includes two elongated prongs spaced apart from each other, the prongs frictionally engaging the knob.

15. The suspension device of claim 10 wherein the elongate member has an elongate center region and the utensil-receiving openings are slots angled toward the center region.

16. The suspension device of claim 10 wherein the utensil-receiving openings are different sizes and shapes from each other.
